(19) United States
(12) Patent Application Publication
(10) Pub. No.: US 2017/0291242 A1
(43) Pub. Date: Oct. 12, 2017

(54) SYSTEMS AND METHODS FOR AUTOMATED STUD PLACEMENT AND WELDING

(71) Applicant: Structural Services, Inc., Bethlehem, PA (US)

(72) Inventors: James T. Benzing, Bethlehem, PA (US); William R. Haller, Bethlehem, PA (US)

(21) Appl. No.: 15/482,109

(22) Filed: Apr. 7, 2017

Related U.S. Application Data
(60) Provisional application No. 62/319,978, filed on Apr. 8, 2016.

(51) Int. Cl. B23K 9/00; B23K 9/10; H04L 12/40; B24B 51/00; H04N 7/18; B23K 9/095; B25J 5/00

(52) U.S. Cl. CPC B23K 9/0026; B23K 9/0956; B23K 9/1087; B25J 5/005; B24B 51/00; H04N 7/183; H04L 12/40; Y10S 901/01; H04B 7/04

(57) ABSTRACT

The present application teaches systems and methods for automating all or portions of a construction process including the steps of locating stud welding locations on the surface of an I-beam, I-beam grinding, ferrule placement, stud placement and welding to ground welding sites, and ferrule fracturing.

### FIELD OF THE INVENTION

This present invention relates generally to systems and method for automated stud placement and welding, and in particular to robotically-controlled stud welders with the capability to identify one or more desired welding sites on a surface of a beam or girder and automatically weld studs at these sites, and related methods therefor.

### BACKGROUND OF THE INVENTION

Currently, each of the steps of grinding of desired weld location on an I-beam, placement of ceramic ferrules that are used to contain the weld pool during the welding process on the ground welding locations, placement of studs within the ferrules, welding of the studs to the I-beam, and then fracturing of the ferrules after the welding step is done manually by an individual walking along the length of the I-beam with or without an appropriate tool. Each of these steps is labor-intensive, time-consuming, and repetitive, and accordingly these steps drive up the costs of construction projects while leading to many worker injuries.

Accordingly, it is desirable to automate all or portions of the process noted above.

### BRIEF DESCRIPTION OF THE DRAWINGS

The invention is best understood from the following detailed description when read in connection with the accompanying figures. According to common practice, the various features of the invention shown in the figures may not be to scale. On the contrary, for purposes of clarity, the dimensions of the various features of the invention shown in the figures may be arbitrarily expanded or reduced. The systems and methods of the present application are further described with reference to the accompanying drawings, in which:

FIG. 1 is an elevated front perspective view of an embodiment of a robotic welding system according to the present invention positioned alongside an I-beam having a plurality of pre-defined welding sites;

FIG. 2 is a top view thereof, with an imager thereof located above the I-beam;

FIG. 3 is a schematic block diagram illustrating components of a system according to the present invention;

FIG. 4 is a schematic block diagram of the computer thereof, including software blocks;

FIG. 5 is a flow chart showing a first method for automated stud placement and welding according to the present invention;

FIG. 6 is a flow chart showing a second method for automated stud placement and welding according to the present invention;

FIG. 7 is a flow chart showing a third method for automated stud placement and welding according to the present invention;

FIG. 8 is a flow chart showing a fourth method for automated stud placement and welding according to the present invention;

FIG. 9 is a diagram of a hand-held weld site locating system in accordance with the present invention; and

FIG. 10 is a schematic block diagram thereof.

### DETAILED DESCRIPTION OF THE PREFERRED EMBODIMENTS

The ensuing detailed description provides preferred exemplary embodiments only, and is not intended to limit the scope, applicability, or configuration of the herein disclosed inventions. Rather, the ensuing detailed description of the preferred exemplary embodiments will provide those skilled in the art with an enabling description for implementing the preferred exemplary embodiments in accordance with the herein disclosed invention. It is understood that various changes may be made in the function and arrangement of elements without departing from the spirit and scope of the invention, as set forth in the appended claims.

To aid in describing the invention, directional terms may be used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification, in order to provide context for other features.

For purposes of the attached specification and claims, the terms “in data communication” and “in electrical communication” have the meaning that components are able to transmit signals, stimuli, or data either unidirectionally or bidirectionally between them.

For purposes of the attached specification and claims, the term “electronic command signal” has the meaning of a signal that is either transmitted or received by an electrical software or hardware component resulting in some resulting action, as would be appreciated by a person of ordinary skill in the fields of electronic engineering, electrical engineering, and software engineering.

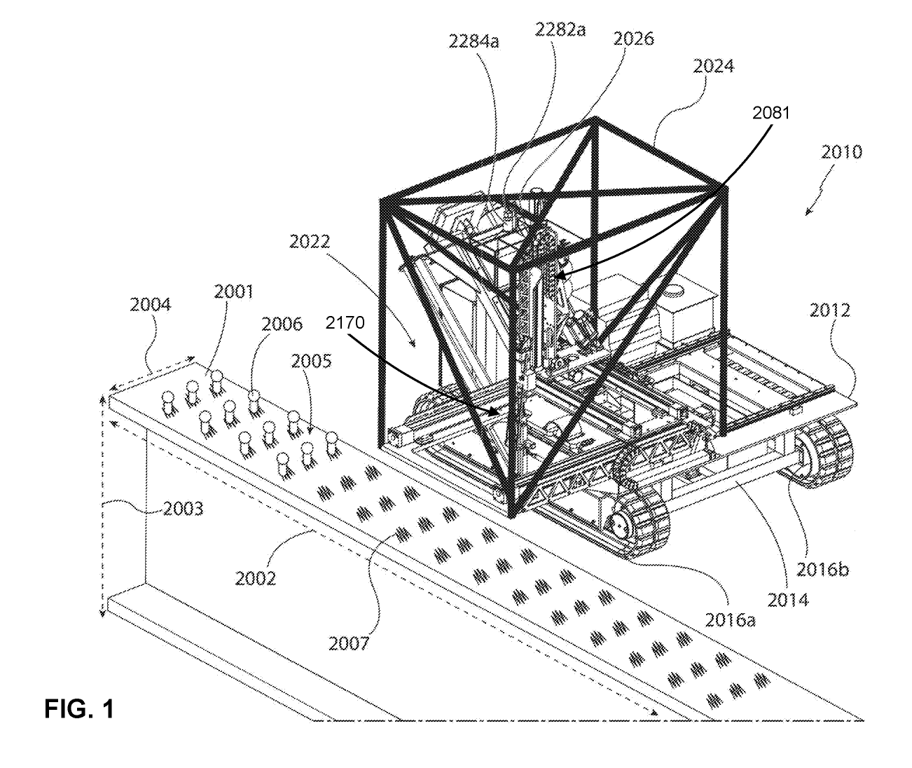

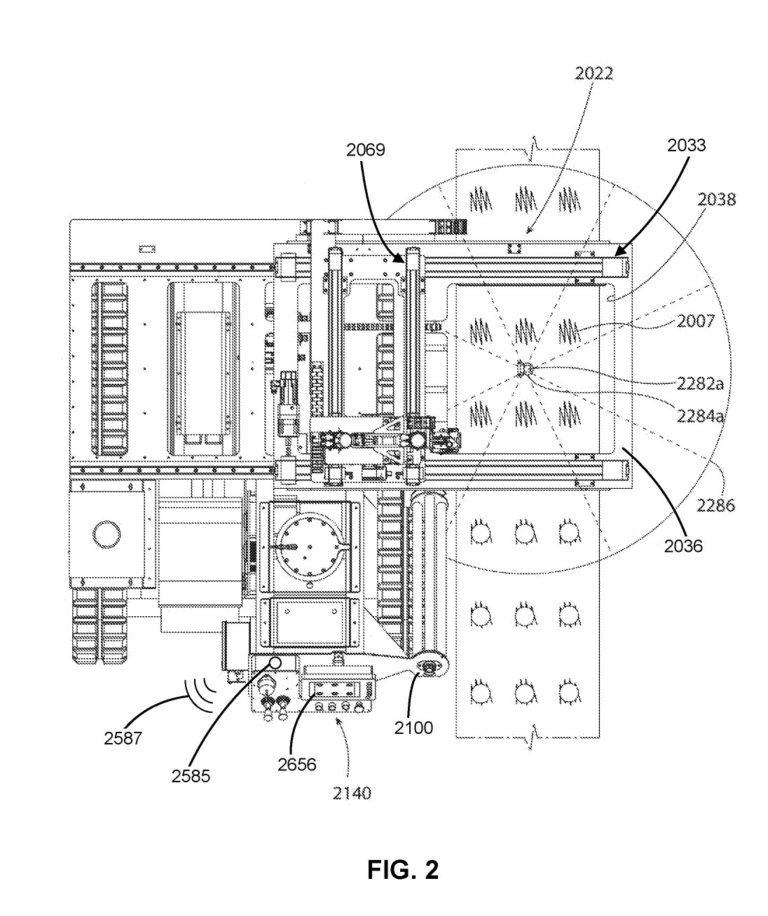

FIGS. 1 and 2 show an embodiment of a welding system 2010 in accordance with the present invention. International Publication No. WO2015/051348A9, which is incorporated herein by reference as if set forth in its entirety, discloses in detail multiple systems and methods for automated welding of studs onto the surface of I-beams. One having ordinary skill in the relevant art area would recognize that the systems and methods disclosed in International Publication No. WO2015/051348A9 are applicable, mutatis mutandis, to the present embodiment of the welding system 2010 and all other embodiments of systems and methods disclosed in the present application. The present application should be read in conjunction with the disclosure of International Publication No. WO2015/051348A9 to further explain the structure and functionality of the embodiment of the automated welding systems and the methods disclosed herein. Conventional techniques for feeding and aligning both studs and ferrules into collets are well known in the art and are disclosed, for example, in U.S. Pat. No. 5,130,510, which is incorporated herein by reference as if set forth in its entirety.

In the embodiment shown in FIGS. 1 and 2, the welding system 2010 is designed to ride alongside an I-beam 2001 to which studs are to be welded. The welding system 2010 comprises a tractor 2012 having a frame 2014 and a pair of tracks 2016a,2016b. During use, the tracks 2016a,2016b move along corrugated support structure panels (e.g., metal panels) or planar planking (e.g., plywood sheets) that have been installed on the work surface adjacent to the I-beam 2001 and between pairs of I-beams, as is traditional in the art.

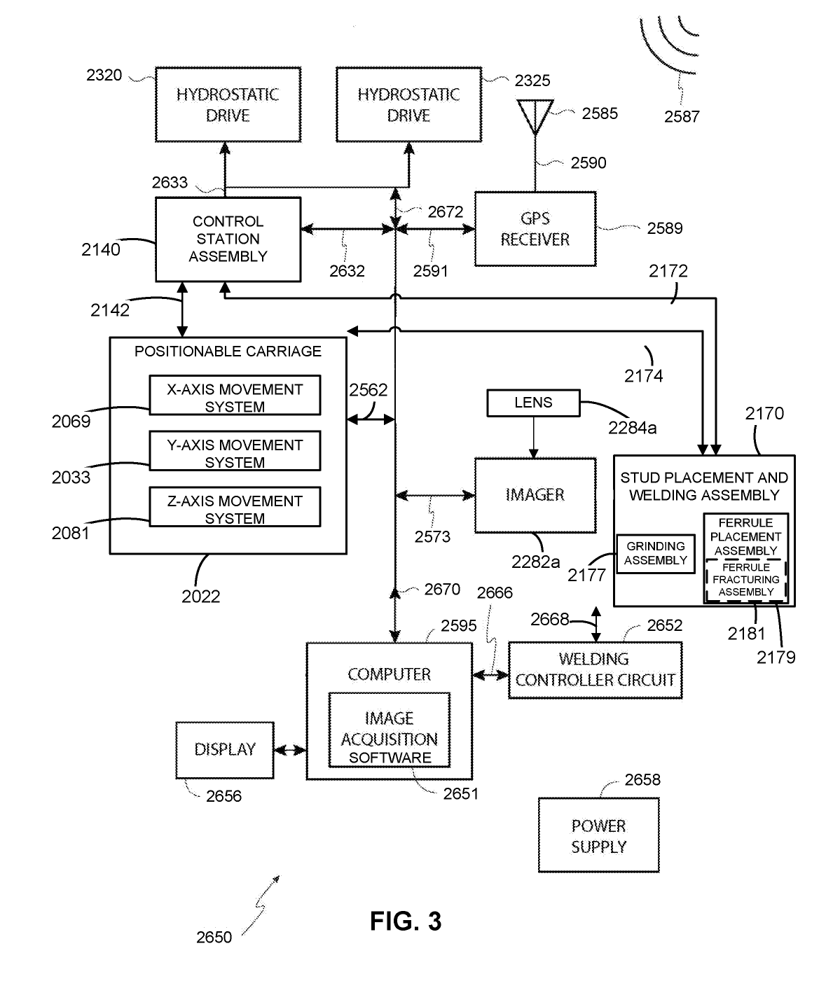

The I-beam 2001 has a longitudinal axis 2002, a vertical height 2003, and a top surface 2005 having a width 2004. On the top surface 2005 of the I-beam 2001, a number of ground welding sites 2007 have been produced, and welded studs 2006 have already been welded to some of the ground welding sites 2007. As would be understood by a person having ordinary skill in the relevant art, ferrules will be used on top of the ground welding sites 2007 in order to encapsulate the molten weld pools during the arc welding process. For convenience, these ferrules are omitted from view in FIGS. 1 and 2. In some methods according to the present invention, the ground welding sites 2007 have already been created by a person who has walked along the length of the beam and ground each of the desired weld locations using a standalone grinding tool. As further described below, in additional methods according to the present invention, the welding system 2010 is equipped with a grinding assembly (shown schematically in FIG. 3) that performs the grinding step in an automated fashion, prior to the stud placement and welding steps that are further described herein, at each of the desired weld locations. As further described below, in some embodiments according to the present invention, the welding system 2010 could be further equipped with a ferrule placement and fracturing assembly (shown schematically in FIG. 3), which places a ferrule on each ground welding site prior to the welding step and then optionally fractures each ferrule after the welding step has been concluded.

As noted above, during operation the welding system 2010 of this embodiment moves alongside and parallel to the longitudinal axis 2002 of the I-beam 2001. In this embodiment, a positionable carriage 2022 comprising a Y-axis movement system 2033, an X-axis movement system 2069, and a Z-axis movement system 2081 is used to physically locate a stud placement and welding assembly 2170 above the top surface 2005 of the I-beam 2001 so that studs can be individually welded to respective ground welding sites 2007. In order to protect the components of the positionable carriage 2022 while on a job site and to reduce ambient light from interfering with the determination of the location of the ground welding sites 2007, an enclosure 2024 comprising a plurality of support beams (shown but not individually labeled in FIG. 1) and a plurality of panels (hidden from view in FIG. 1 in order to illustrate the components of the positionable carriage 2022) is used. In this embodiment, the panels are planar and removably attach to the respective one or more support beams via known fasteners. An imager support bracket 2026 forms a portion of the roof portion of the enclosure 2024. Imager support bracket 2026 supports the imager 2282a from the top of the enclosure 2024. The imager 2282a will be discussed in greater detail below.

FIG. 2 is a top view of the welding system 2010, with the positionable carriage 2022 and imager 2282a located above the top surface 2005 of the I-beam 2001. The imager 2282a further comprises a lens 2284a attached thereto for enhancing the field of view 2286 of the imager 2282a. The imager 2282a is attached to the imager support bracket 2026 of the enclosure 2024. The relevant portion of the field of view 2286 of the imager 2282a encompasses all of that portion of the top surface 2005 of the I-beam 2001 that is located below and within the perimeter of an opening 2038 in a sliding base plate 2036 of the positionable carriage 2022. Although the field of view 2286 of the imager 2282a is larger than the area of the opening 2038, the remainder of the image captured by the imager 2282a is cropped before being used to calculate the locations of the ground welding sites 2007. In this embodiment, the opening 2038 is rectangular in shape and sized such that it is wider than the width 2004 of the I-beam 2001, and such that at least the side edges of the top surface 2005 of the I-beam 2001 and a two-by-three grid of ground welding sites 2007 (or ground welding sites 2007 and ferrules, for example) is visible to the imager 2282a within the opening 2038 at one time. As shown in FIG. 2, in this embodiment the imager 2282a is located directly above the center of the area of the opening 2038. Therefore, during operation, when the positionable carriage 2022 is moved such that the imager 2282a is approximately centered about the width 2004 of the I-beam 2001, the opening 2038 is likewise centered about the width 2004 of the I-beam, with the entire width 2004 of the I-beam 2001 visible to the imager 2282a within the opening 2038. It should be understood that, in alternate embodiments, the opening 2038 in the sliding base plate may have different shapes, for example square, circular, or oval, or may be sized such that a greater or lesser number of ground welding sites 2007 are typically visible to the imager 2282a within the opening 2038 provided in the sliding base plate 2036 at one time.

In this embodiment, the welding system 2010 further comprises a control station assembly 2140 including movement controls (not labeled) for the positionable carriage 2022, welding controls (not labeled) for the stud placement and welding assembly 2170, and a display 2656 that provides a visual display of the field of view 2286 of the imager 2282a. As discussed below, the display 2656 can be used to display additional features of the invention. In this embodiment, the welding system 2010 further comprises a GPS antenna 2585 supported from the control station assembly 2140. With reference to the schematic diagram of FIG. 3, GPS antenna 2585 is configured to receive conventional GPS signals 2587 from any one of the global positioning systems and is in electrical communication with a GPS receiver 2589 via a cable 2590. GPS receiver 2589 is further adapted to receive real time kinematic (RTK) data for increasing the location determining capability of GPS antenna 2585 via a separate communication channel (not shown).

GPS receiver 2589 may be further adapted to use other positioning systems to accurately locate the position of GPS antenna 2585, such as a local based pseudo-GPS system, which may be further employed if satellite GPS signals are not available as might be experienced, for example, in an enclosed structure such as a building. GPS antenna 2585 may alternatively be mounted to the positionable carriage 2022. Any other position on welding system 2010, including the position of the stud placement and welding assembly 2170, may be determined by correcting for positional offsets from GPS antenna 2585 to the particular component position location. GPS receiver 2589 communicates with computer 2595 (discussed below) via communication channel (local bus cable) 2591. In an alternate embodiment, a second GPS antenna (not shown) and a second GPS receiver could be included as part of the welding system 2010 and used to determine the location of the stud placement and welding assembly 2170.

GPS antennas and cooperating receivers are offered by a number of manufactures including Trimble Navigation, Ltd. of Sunnyvale, Calif., Topcon Positioning Systems, Inc. of Livermore, Calif., and Leica Geosystems, Inc. of Norcross, Ga. Other GPS and non-GPS based systems are offered for determining the geographical position of objects and include for example LIDAR (light distance and ranging) systems (using triangulation), and are well known in the art of surveying. For example, a modern day “total solution” represents a complete electronic surveying tool incorporating one or more electronic theodolites along with accurate LIDAR systems to accurately determine the position of objects, and can precisely locate an object using for example known triangulation techniques. Any of these or other known location-determining devices could be employed, either in place of or in combination with GPS antenna 2585 and GPS receiver 2589, to permit the welding system 2010 to determine its location and the location of its various components with high accuracy.

As will be discussed below in detail, the welding system 2010 could be employed in a number of different methods of automating all or portions of the stud placement and welding process, including automated grinding of the top surface 2005 of the I-beam 2001 at desired weld site location(s) and automated ferrule placement and fracturing. In some of these methods, the GPS-enabled features are employed so that the welding system 2010 is aware of its position—and the position of each of its relevant components, e.g., the stud placement and welding assembly 2170—relative to the I-beam 2001.

Referring back to FIG. 3, a schematic block diagram 2650 of welding system 2010 is shown and comprises computer 2595 having a software module for image acquisition 2651, display 2656 connected to the computer 2595, GPS receiver 2589, imager 2282a connected to lens 2284a, a welding controller circuit 2652 connected to the stud placement and welding assembly 2170 via local bus 2668, a power supply 2658 (e.g., a battery), control station assembly 2140, right hydrostatic drive 2320, left hydrostatic drive 2325, and the positionable carriage 2022 that includes the X-axis movement system 2069, Y-axis movement system 2033, and Z-axis movement system 2081.

Computer 2595 communicates with imager 2282a via local bus 2573, GPS receiver 2589 communicates with computer via local bus 2591, control station assembly 2140 communicates with computer 2595 via local bus 2632, the X-axis movement system 2069, Y-axis movement system 2033, and Z-axis movement system 2081 of the positionable carriage 2022 communicate with computer 2595 via local bus 2562, and the right hydrostatic drive 2320 and left hydrostatic drive 2325 are connected to the computer 2595 via local bus 2672. In this embodiment, all local busses 2573, 2591, 2632, 2562 and 2672 are grouped together and become part of main communication bus 2670, and all components connected to main communication bus 2670 are in bi-directional communication with each other. In FIG. 3, the connections for the power supply 2658 are omitted from view, but it should be understood that the power supply 2658 powers the computer 2595, display 2656, and other components of the welding system 2010 shown in FIG. 3. Computer 2595 further comprises communication ports which allow for the attachment of computer peripherals. These communication ports include, for example, USB ports, wireless connections such as WiFi and Bluetooth, and internet connectivity.

The hydrostatic drives 2320, 2325 are connected to the control station assembly 2140 via local bus 2633. Control station assembly 2140 is connected to the X-axis movement system 2069, Y-axis movement system 2033, and Z-axis movement system 2081 of the positionable carriage 2022 via local bus 2142 and to the stud placement and welding assembly 2170 via local bus 2172. In addition, the X-axis movement system 2069, Y-axis movement system 2033, and Z-axis movement system 2081 of the positionable carriage 2022 are connected to the stud placement and welding assembly 2170 via local bus 2174.

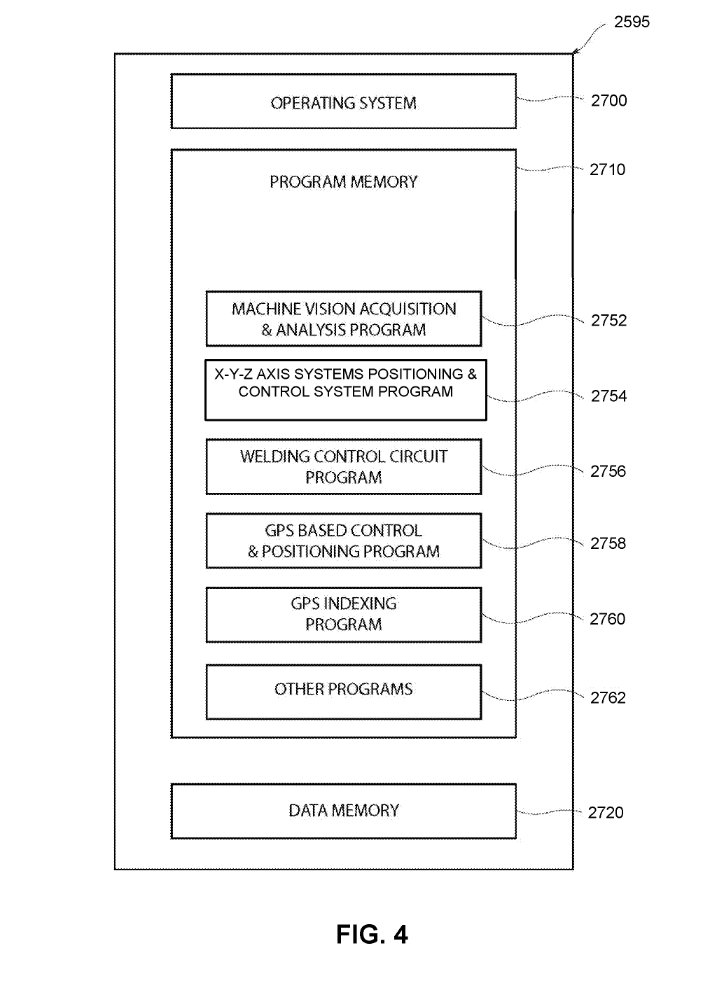

Referring now to FIG. 4, computer 2595 further comprises operating system (OS) program 2700, program memory 2710, and data memory 2720. In this embodiment, OS program 2700 is a conventional real-time operating system (RTOS). In alternate embodiments the OS program 2700 may be a Windows-based operating system or other available operating system, such as LINUX. OS program 2700 is able to execute programs contained in program memory 2710 by conventional means.

Program memory 2710 comprises machine vision acquisition and analysis program 2752 that controls the acquisition of images from imager 2282a. Control signals are sent to imager 2282a by program 2752 and include image trigger signal (i.e., when to acquire a raw image) and an electronic shutter signal (i.e., for how long should the image be acquired). Program 2752 also includes the camera calibration algorithm which corrects the raw image data input from imager 2282a for lens 2284a distortion and other non-ideal camera and image parameters. When an image is triggered, program 2752 then stores the calibrated image data to data memory 2720.

For some methods according to the present invention, program 2752 also analyzes the stored image captured by imager 2282a and identifies each ground welding site 2007 (or each grind/weld-location marking, as further discussed below) within the captured image using conventional image segmentation and other known image analysis algorithms. Such algorithms include image thresholding algorithms where ground welding sites 2007 are identified using the difference in grayscale values between the bright reflective welding site and the dull non-reflecting beam surface, as is well known in the art of image processing and analysis. Character recognition algorithms, which are well known in the art of image processing and analysis, may be used to determine weld locations where grind/weld-location marking(s)—e.g., “X”s—are provided on the top surface 2005 of the I-beam 2001 instead of ground welding sites 2007.

For some methods according to the present invention, program 2752 further identifies the center of each welding site (which may include the center of a manually placed ferrule), calculates the convention (u-v) pixel coordinates of the center of each non-repeated identified welding site, calculates the X-Y positions of the center of each non-repeated welding site, identifies the location of the beam edges of I-beam 2001, determines the respective u coordinates for the line images of beam edges, determines the number of pixels between the line images of the beam edges of I-beam 2001 using the line image u coordinates, and calculates the image pixel distance to object distance ratio from the beam edges of I-beam 2001 using beam width input data in addition to other image analysis and processing functions. Data including the (u,v) pixel coordinates of the center of every identified welding site and the X-Y coordinates for each welding site, along with the calculated pixel to object distance ratio is stored in data memory 2720, in addition to other data. Program 2752 also computes, using the camera calibration algorithm, the camera calibration parameters which are used to correct the raw image for lens distortion and stores these parameters in data memory 2720.

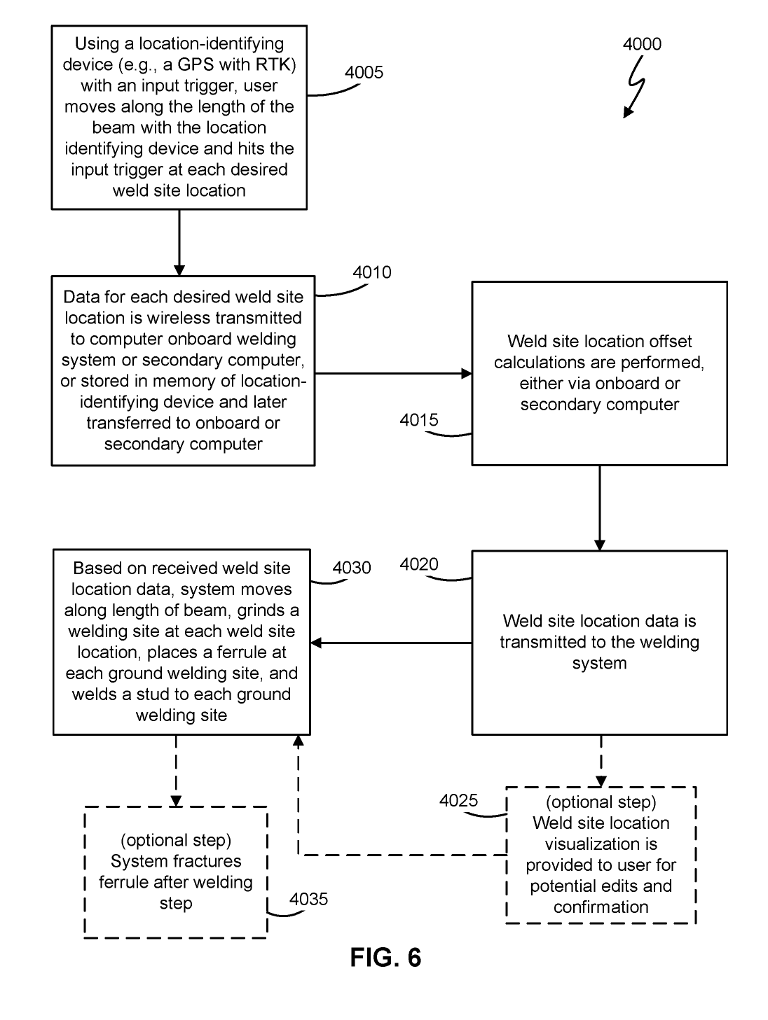

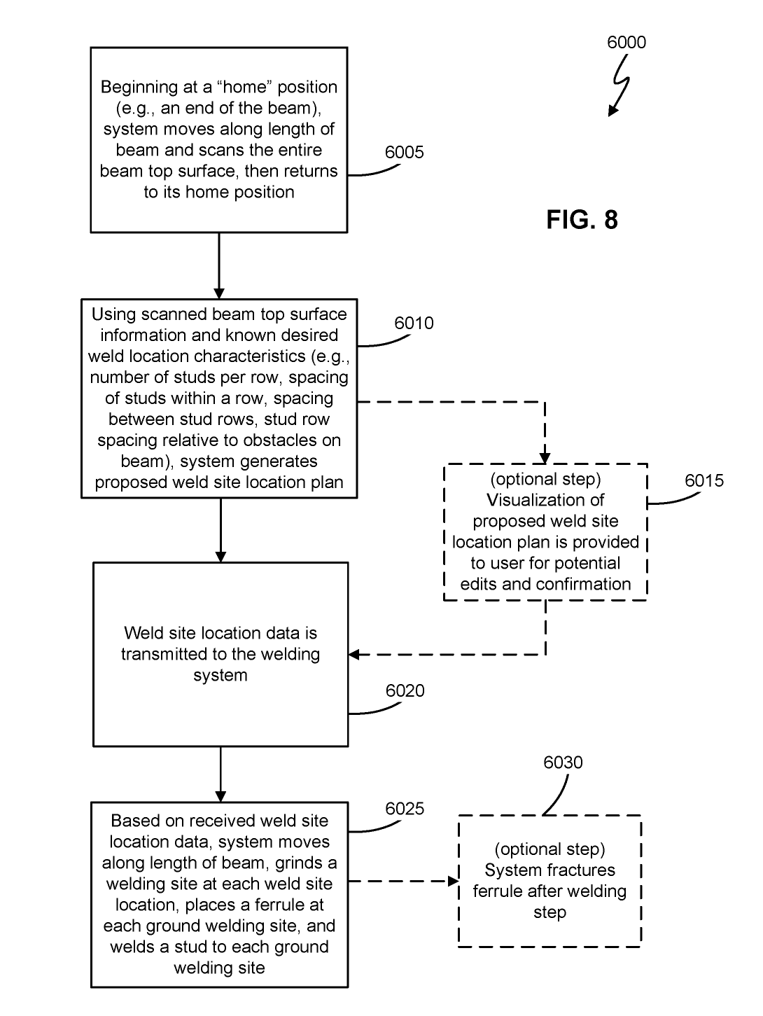

Program memory 2710 further comprises X-Y-Z systems positioning and control system program 2754. Program 2754 is used for controlling the position of the X-axis movement system 2069, Y-axis movement system 2033, and Z-axis movement system 2081 so that the stud placement and welding assembly 2170 can be brought into the correct locations for welding studs to the top surface 2005 of the I-beam 2001. Program memory 2710 further comprises welding control circuit program 2756, which interfaces with the welding controller circuit 2652 and controls the stud arc-welding process that is performed by the stud placement and welding assembly 2170. Program memory 2710 may also comprise other programs 2762, for example a program for performing location offset calculations to calculate weld site locations on an I-beam 2001 based on received location data from a location-identifying device (e.g., a GPS device), as discussed in further detail below with respect to the method shown in FIG. 6, and/or a weld site-location planning software module that is used to generate a proposed weld site-location plan according to acquired image information from the I-beam 2001 and inputted weld location information, as discussed in further detail below with respect to the method shown in FIG. 8.

Program memory 2710 further comprises GPS based control and positioning program 2758, which acts to input the welding site GPS location coordinates from a USB memory stick connected to computer 2595 or receives the welding site GPS location coordinates via other available communication ports previously disclosed (for example, through internet, Bluetooth, or WiFi connectivity), and stores these coordinates in data memory 2720. Additionally, the welding site coordinates could also be directly entered via a data-input means, such as a keyboard that is connected to the computer 2595. Thus, it should be understood that the welding site GPS coordinates may be used exclusively for forming the welding site coordinates contained in data memory 2720, or may be used in combination with the welding site coordinates determined using machine vision, either coordinate sets being transformed by program 2758 to be compatible with each other and other programs and systems. Program 2758 further compares the GPS position of the stud placement and welding assembly 2170 with previously-stored welding site GPS coordinates, and moves the stud placement and welding assembly 2170 to each set of desired welding site GPS coordinates via X-Y-Z systems positioning and control system program 2754 and the X-axis movement system 2069, Y-axis movement system 2033, and Z-axis movement system 2081 of the positionable carriage 2022.

Additionally, as further detailed below, the GPS coordinates of the location of I-beam 2001 (for example, the location of its side edges) and characteristics of the I-beam 2001 such as the length of its longitudinal axis 2002 and width 2004 may be inputted via a keyboard or by other means (such as USB or wireless connection) into computer 2595 and used by program 2758 to construct a welding path for welding system 2010 to follow. Other positional data may be entered into the computer 2595 to indicate “no welding” areas on the top surface 2005 of the I-beam 2001.

Program memory further includes GPS indexing program 2760, which may be used to automatically move the stud placement and welding assembly 2170 in a predefined pattern according to pre-programmed GPS positions and, in combination with other automated functionality of the welding system 2010, is able to weld studs at welding sites defined by an indexed position. Thus, as further detailed below, GPS indexing program 2760 allows for both the placement and welding of studs at pre-defined positions on the top surface 2005 of I-beam 2001.

In the present embodiment of the welding system 2010, once the imager 2282a has made a determination (if applicable) of where the ground welding sites 2007 are located on the top surface 2005 of the I-beam 2001, this information is used to communicate to the stud placement and welding assembly 2170 precisely where studs should be welded onto the top surface 2005 of the I-beam 2001. In this embodiment, a stud feeding assembly 2100 is used to feed studs to the stud placement and welding assembly 2170 so that the studs may be welded onto the I-beam 2001. Employing the principles discussed above in detail, the location of the stud placement and welding assembly 2170 within the positionable carriage 2022 with respect to the frame 2014 and the I-beam 2001 will be stored in computer 2595, and this information will be used to make the appropriate calculations and communicate how the stud placement and welding assembly 2170 is to be moved, via control of the X-axis movement system 2069, Y-axis movement system 2033, and Z-axis movement system 2081, in order to bring the stud placement and welding assembly 2170 and enclosed studs into the correct locations on the top surface 2005 of the I-beam 2001.

As noted above, the present invention comprises various methods of using the welding system 2010 to automate all or portions of the beam grinding, ferrule placement, and stud placement and welding operations that are currently performed manually.

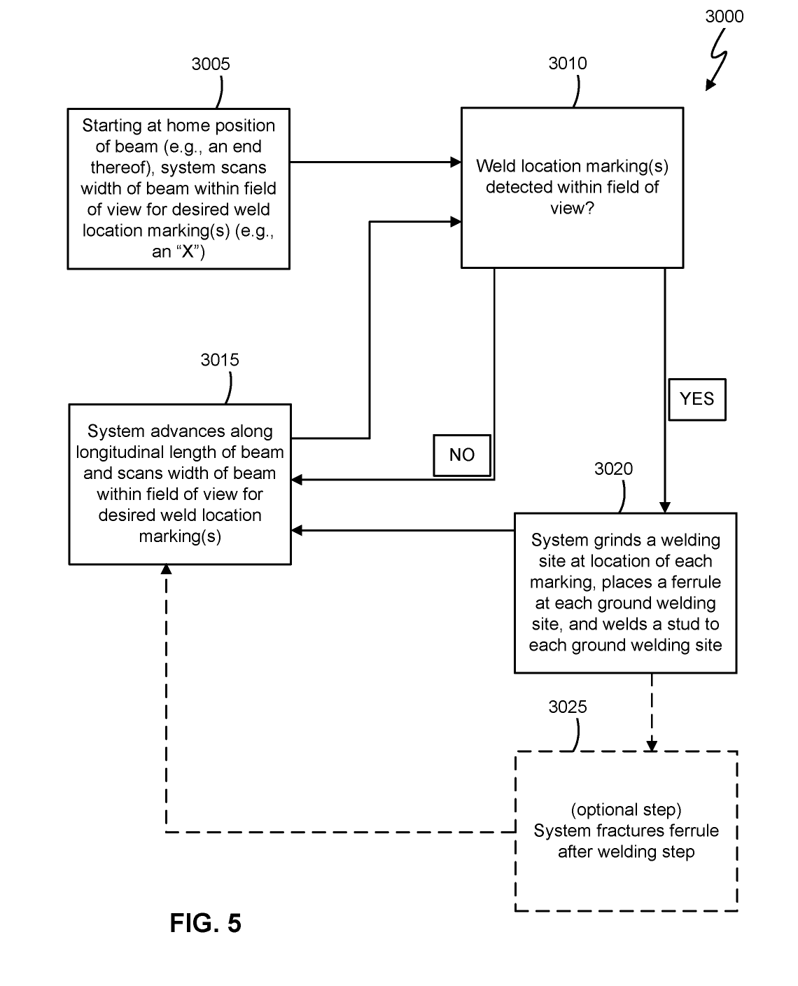

FIG. 5 is a flow chart showing a first method 3000 for automated stud placement and welding according to the present invention. The method 3000 permits a user to manually mark the I-beam 2001 with each desired weld location, e.g. with a paint gun, and then the welding system 2010 performs the grinding, stud placement, and welding steps in an automated manner. The method 3000 begins at step 3005 wherein the welding system 2010, which has been located adjacent to the I-beam 2001 at a “home” position (e.g., an end of the I-beam 2001), scans the width 2004 of the top surface 2005 of the I-beam 2001 within the field of view 2286 of the imager 2282a for desired weld location marking(s) (which might be, for example, an “X”-shaped marking on the top surface 2005 of the I-beam 2001). Using the image collection and analysis techniques taught herein, the welding system 2010 determines, at step 3010, whether any suitable weld location markings are located within the field of view 2286. If, at step 3010, it is determined that no suitable weld location marking is located within the field of view 2286, the method moves to step 3015 wherein the welding system 2010 advances along the length of the I-beam 2001 to establish a new field of view 2286 corresponding with a different portion of the length of the I-beam 2001, scans the width 2004 of the top surface 2005 of the I-beam 2001 for suitable weld location markings, and then returns to step 3010. If, at step 3010, the system determines that suitable weld location marking(s) are located within the field of view 2286, the method moves to step 3020 where the welding system 2010 grinds a welding site at the location of each weld location marking using grinding assembly 2177, places a ferrule at each ground welding site 2007 using ferrule placement assembly 2179, places a stud within each ferrule, and welds the stud to the I-beam 2001 at each of these locations. In embodiments where the welding system 2010 lacks a plunger for fracturing the ferrules after the welding step has been performed, the method returns to step 3015. In the alternative, if the welding system 2010 has a ferrule fracturing assembly 2181 (e.g., a pointed plunger), the welding system 2010 fractures each ferrule at step 3025 after the welding step occurs, and then the method returns to step 3015. In the method 3000 shown in FIG. 5, once the welding system 2010 has reached the end of the I-beam 2001 (as recognized by the welding system 2010 within the field of view 2286 according to the methods taught herein), the method 3000 ends and the welding system 2010 returns to its home position of step 3005.

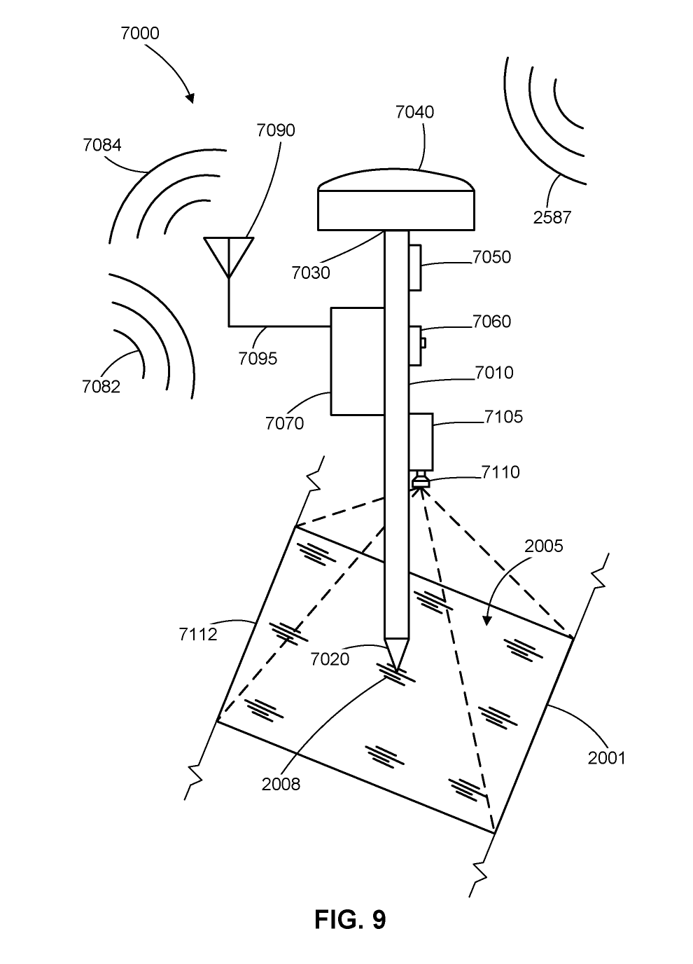

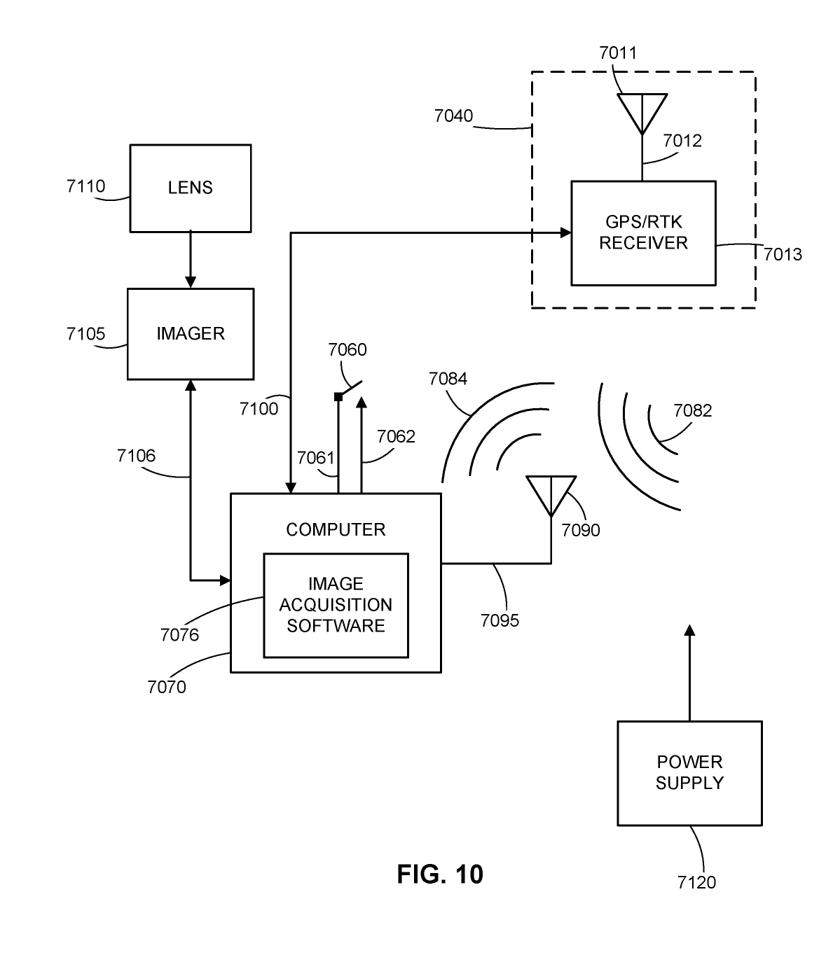

FIG. 6 is a flow chart showing a second method 4000 for automated stud placement and welding according to the present invention. Instead of needing to physically mark each desired weld location, as in the method 3000 of FIG. 5, the method 4000 permits a user to use a location-identifying device (e.g., a pole-mounted GPS device with RTK data capability, an input “trigger” or switch, and an optional onboard computer or memory storage module) to capture the spatial coordinates of each desired weld location along the length of the I-beam 2001 and supply these coordinates to the welding system 2010. The method 4000 begins at step 4005, wherein a person moves along the length of the I-beam 2001 with a location-identifying device in hand (e.g., a pole-mounted GNSS system such as those known in the art, for example the R8 GNSS System produced by Trimble Navigation Limited of Sunnyvale, Calif., U.S.A mounted to a suitable surveyor's pole), places the location-identifying device in some pre-defined spatial relationship with respect to each desired welding site (e.g., in direct contact with the top surface 2005 of the I-beam 2001), and performs an action (e.g., pushes a button) so that a geolocation-determining signal is sent to the onboard computer and thus used to record the geolocation of the location identifying-device at that point in time. At step 4010, the geolocation data for each desired weld site location is either (1) wirelessly transmitted from the location-identifying device to the computer 2595 onboard the welding system 2010 via GPS antenna 2585 or a separate antenna (e.g., a Wi-Fi antenna); (2) wirelessly transmitted to an on-site or remotely-located secondary computer; or (3) locally stored in a memory location of the location-identifying device for later transfer to the onboard computer 2595 or a secondary computer. At step 4015, either the onboard computer 2595—via an installed, appropriate software program 2762—or the secondary computer will perform position offset calculations to convert the geolocation data received from the location-identifying device to geolocation data that directly corresponds to the desired weld sites. For example, if a unit of recorded data was received from a GPS device located 5 centimeters above a desired weld location at the time of data recording, the software will perform the necessary offset calculation to change the geolocation coordinates in the computer to reflect a position that is 5 centimeters in the negative direction along a standard “Z”-axis in the calculated data set. As such, the actual data set of desired weld site locations is compiled. At step 4020, the actual weld site location data is transmitted to the welding system 2010, either from its onboard computer 2595 or wirelessly or via a local communication port from the secondary computer. Optionally, the welding system 2010 can provide a visualization of the weld site location plan for potential user edits and confirmation at step 4025 before continuing to step 4030 discussed below. The method 4000 then moves to step 4030 wherein the welding system 2010, utilizing the provided weld site location data and its own GPS capabilities discussed above, moves along the I-beam 2001, grinds a welding site at the location of each desired weld site location, places a ferrule at each ground welding site 2007, places a stud within each ferrule, and welds the stud to the I-beam 2001 at each of these locations. In embodiments where the welding system 2010 lacks a plunger for fracturing the ferrules after the welding step has been performed, the method 4000 is now completed. In the alternative, if the welding system 2010 has a plunger or other means for fracturing ferrules, the welding system 2010 fractures each ferrule at step 4035 after each weld occurs. Related apparatuses and methods are discussed with respect to FIGS. 9 and 10, below.

In some methods according to the present invention, the operator may choose to pre-determine the GPS location of the welding sites 2008 without using the welding system 2010 discussed above. Referring now to FIGS. 9 and 10, another embodiment of the present invention will be described in detail. In this embodiment, a weld site locating system 7000 comprises a hand-held pole 7010 having a pointed end 7020 proximal to the top surface 2005 of I-beam 2001 and having distal end 7030. Pole 7010 may be, for example, model number 5125-20-YEL manufactured by SECO of Redding, Calif., and may be constructed from aluminum or another type of suitable material. Pole 7010 may be one-piece or sectioned to allow disassembly and/or may be telescopically constructed. In this embodiment, a GPS/RTK antenna and receiver combination 7040 is attached at the distal end 7030 of the pole 7010 and is operationally configured to receive GPS and RTK signals 2587 as previously described above with reference to FIG. 3. GPS/RTK antenna and receiver combination 7040 comprises antenna 7011 connected via communication channel 7012 to GPS/RTK receiver 7013. The GPS/RTK receiver 7013 computes a more accurate GPS position of the antenna 7011 using the received RTK signals 2587. The RTK-corrected GPS position of antenna 7011 is placed onto a bus 7100, which is in electrical communication between the GPS/RTK receiver 7013 and a computer 7070, which in this embodiment is mounted onto the pole 7010 but in the alternative could be carried by the operator.

In this embodiment, also attached to pole 7010 is a visual level 7050 which gives an indication to the operator when pole 7010 is vertically placed over welding site 2008 on the surface 2005 of the I-beam 2001. Level 7050 may be, for example, model number 5198-054 manufactured by SECO. In this embodiment, also attached to pole 7010 is a manually-operated trigger switch 7060 and the computer 7070. The computer 7070 includes image acquisition software 7076. In this embodiment, computer 7070 is a fully functional computer having a RTOS or other commonly available operating system, for example Windows.

Additionally, in this embodiment the computer 7070 has communication ports (not shown) which allow for the attachment of computer peripherals. These communication ports may include for example USB, Wi-Fi, Bluetooth, and internet connectivity. For example, Wi-Fi signals—which are represented by radio waves 7082 and 7084—are being respectively received by and transmitted from an antenna 7090 that is in electrical communication with computer 7070 via electrical cable 7095. In this embodiment, antenna 7090 is operably configured to transmit and receive Wi-Fi signals.

A switch 7060 is in electrical communication with computer 7070 via wires 7061 and 7062. Further attached to pole 7010 is a calibrated imager 7105 having a lens 7110. Imager 7105 and lens 7110 are similar to imager 2282a and lens 2284a respectively, which are discussed above in detail. Lens 7110 focuses an area 7112 (in some embodiments, the field of view extends beyond the edges of the top surface 2005 of the I-beam 2001) onto the imaging element of imager 7105. Imager 7105 is in bidirectional communication with computer 7070 via a bus 7106. Electrical power is provided to all components by a power supply 7120, which may be attached to the pole 7010 or carried by the operator. For simplicity, the power supply 7120 is not shown in FIG. 9, and the individual power connections are not shown in FIG. 10.

In a first mode of operation of the weld site locating system 7000, an operator first places the pole end 7020 into physical contact with the welding site 2008, and then moves pole 7010 into a vertical position using the level 7050. The operator then depresses the trigger switch 7060 for a short period of time (e.g., approximately 1 second), which closes the switch 7060 and sends a signal to the computer 7070 via wires 7061 and 7062. In response to closure of the switch 7060, computer 7070 inputs the then-current RTK-corrected GPS location of the antenna 7011 (i.e., the phase center of antenna 7011) from the receiver 7013 via bus 7100 and performs a vertical offset calculation (based upon the length of pole 7010) to calculate the GPS/RTK position of the welding site 2008. This offset corrected welding site GPS/RTK positional data is stored into the data memory of computer 7070.

The operator then sequentially repeats the above process for each welding site located on the top surface 2005 of the I-beam 2001 so that the GPS/RTK-offset corrected positions of all welding sites have been determined and saved into the computer 7070. Having obtained all of the welding site locational data, the operator may then depress the switch 7060 for a longer period of time (e.g., approximately 5 seconds) than the period of time that was previously used to input welding site location data. The longer depression signal sent to switch 7060 communicates to the computer 7070 that the recording process has ended, and that all weld site location data is to be transmitted to welding system 2010. This data can then be used to construct a positional map of all of the recorded welding sites located on the top surface 2005 of the I-beam 2001.

As noted above, antenna 7090 is in electrical communication with computer 7070 via electrical cable 7095 and is operably configured to transmit to and receive Wi-Fi signals from, for example, the welding system 2010 via the Wi-Fi connection (or other suitable communication channel established between the computer 7070 and the computer 2595 of the welding system). Having received the GPS/RTK welding site location data, welding system 2010 may then proceed to weld studs at the appropriate sites, as discussed above in detail.

Alternately, the welding site location data which has been stored in data memory of computer 7070 can be loaded into a portable data storage device, such as a USB memory stick, which may then be inserted into a communication port of computer 2595. Welding site location data is then loaded from the USB memory stick into data memory 2720 of computer 2595.

In a second mode of operation of the weld site locating system 7000, an operator first places pole end 7020 onto the top surface 2005 of the I-beam 2001 in close proximity to at least one welding site 2008 and then moves pole 7010 into a vertical position using level 7050. The operator then depresses trigger switch 7060 for two short periods of time (e.g., each approximately 1 second), which closes the switch 7060 and signals the computer 7070 via lines 7061 and 7062. In response to the two closures of the switch 7060, computer 7070 inputs the current RTK-corrected GPS location of antenna 7011 (i.e., the phase center of antenna 7011) from the receiver 7013 via bus 7100 and performs a vertical offset calculation (based upon the length of pole 7010) to calculate the GPS/RTK location of the pole end 7020 (which is still in contact with beam surface 2005). This offset corrected welding site GPS/RTK positional data is stored into the data memory of computer 7070.

In further response to the double switch closure, computer 7070 triggers camera 7105 to image the at least one welding site 2008 (or multiple welding sites within the area 7112) via the image acquisition software 7076. Based upon this calibrated image, the computer 7070 computes the GPS/RTK locations of each welding site contained within the area 7112. This welding site location data is then stored in the data memory of computer 7070, which in a similar fashion as described above, may be transmitted to computer 2595 wirelessly via Wi-Fi or via a USB memory stick. Pole 7010 may also include a ferrule placement apparatus which is operably configured to place a ferrule at each welding site.

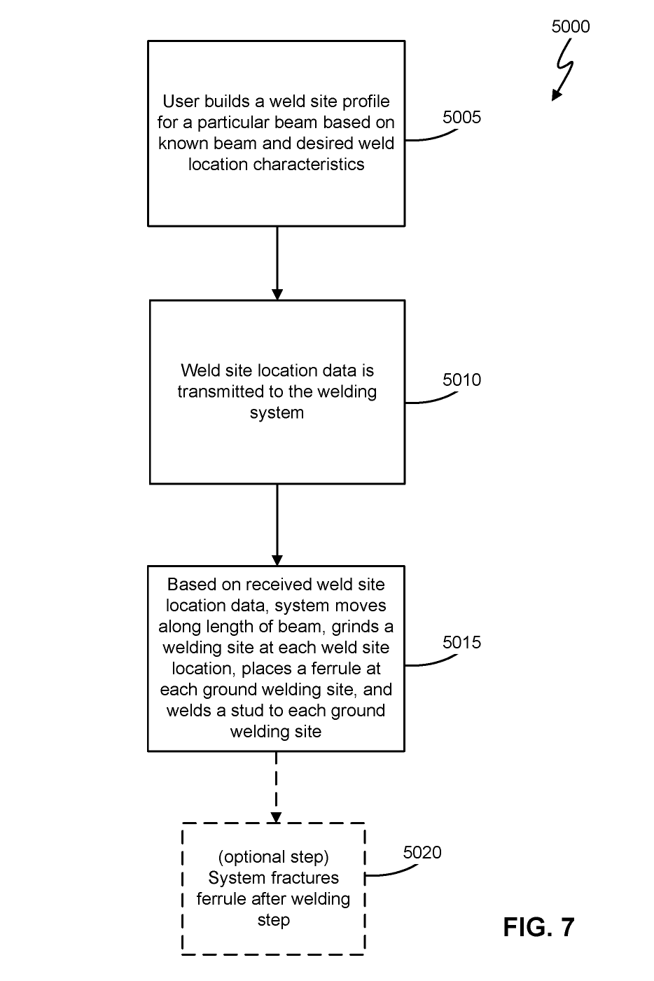

FIG. 7 is a flow chart showing a third method 5000 for automated stud placement and welding according to the present invention. In this method 5000, at step 5005 a user designs a stud welding plan in a computer (which could be, for example, onboard computer 2595) based on known I-beam 2001 characteristics (e.g., beam length and width 2004) and desired weld location characteristics (e.g., number of studs per row, spacing of studs within a row, spacing of outer studs from I-beam 2001 edges, spacing between rows of studs, location(s) of “no weld” zone(s) located on the top surface 2005 of the I-beam 2001, desired stud row spacing relative to “no weld” zone(s)) and transmits this weld site location data to the welding system 2010 at step 5010. The method 5000 then moves to step 5015 wherein the welding system 2010, utilizing the provided weld site location data—and if necessary its own GPS capabilities discussed above—moves along the I-beam 2001, grinds a welding site at the location of each desired weld site location, places a ferrule at each ground welding site 2007, places a stud within each ferrule, and welds the stud to the I-beam 2001 at each of these locations. In embodiments where the welding system 2010 lacks a plunger for fracturing the ferrules after the welding step has been performed, the method 5000 is now completed. In the alternative, if the welding system 2010 has a plunger or other means for fracturing ferrules, the welding system 2010 fractures each ferrule at step 5020 after each weld occurs.

FIG. 8 is a flow chart showing a fourth method 6000 for automated stud placement and welding according to the present invention. This method 6000 uses the imager 2282a and image acquisition software module 2651 of the computer 2595 of the welding system 2010 to first acquire and stitch together a composite image of the entire top surface 2005 of the I-beam 2001, before using this image along with known weld location characteristics to generate a weld site location plan for the I-beam 2001. Specifically, at step 6005 of the method 6000, the welding system 2010 starts at a “home” position (e.g., an end of the I-beam 2001), moves along the length of the I-beam 2001 while scanning the entire top surface 2005 thereof using its imager 2282a, and then returns to its home position. At step 6010, the computer 2595 of the welding system 2010 then compiles a composite image of the entire top surface 2005 of the I-beam 2001. The computer 2595 then uses a weld site-location planning software module 2762 that is stored in the computer 2595, along with inputted desired weld location characteristics (e.g., number of studs per row, spacing of studs within a row, spacing of outer studs from I-beam 2001 edges, spacing between rows of studs, location(s) of “no weld” zone(s) located on the top surface 2005 of the I-beam 2001, desired stud row spacing relative to “no weld” zone(s)) to generate a proposed weld site location plan. At step 6015, the computer 2595 optionally generates a visualization of the proposed weld site location plan and presents this plan to a user (e.g., via display 2656 of welding system 2010 or a separate computer or smartphone-enabled application) for potential edits and confirmation before the weld site location data is transmitted to the welding system 2010 at step 6020. The method 6000 then moves to step 6025 wherein the welding system 2010, utilizing the provided weld site location—and if necessary its own GPS capabilities discussed above—moves along the I-beam 2001, grinds a welding site at the location of each desired weld site location, places a ferrule at each ground welding site 2007, places a stud within each ferrule, and welds the stud to the I-beam 2001 at each of these locations. In embodiments where the welding system 2010 lacks a plunger for fracturing the ferrules after the welding step has been performed, the method 6000 is now completed. In the alternative, if the welding system 2010 has a plunger or other means for fracturing ferrules, the welding system 2010 fractures each ferrule at step 6030 after each weld occurs.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What we claim is:

1. An apparatus for automatically welding a stud to a surface of a beam at each of at least one desired welding sites located on the surface of the beam, the beam having a longitudinal axis, the apparatus comprising:
a carriage that is operably configured to be moveable parallel to the longitudinal axis of the beam;
at least one welding assembly attached to the carriage;
at least one computer;
at least one data input source; and
at least one antenna;
the at least one computer being in data communication with the carriage, the at least one welding assembly, the at least one data input source, and the at least one antenna, the at least one computer being operably configured to use geolocation-determining signals received by the antenna to determine geolocations of the carriage and the at least one welding assembly, the at least one computer being further operably configured to receive location data from the at least one data input source regarding a respective geolocation of each of the at least one desired welding sites, and the at least one computer being further operably configured to send an electronic command signal to the at least one welding assembly to automatically place and weld a stud to the surface of the beam at each of the at least one desired welding sites.

2. The apparatus of claim 1, further comprising at least one imager connected to the carriage and being in data communication with the at least one computer, the imager being operably configured to capture a plurality of images of the surface of the beam as the carriage is being moved parallel to the longitudinal axis of the beam, the at least one computer being operably configured to identify at least one pre-marked welding site that is located on the surface of the beam in one or more images of the plurality of images and to determine the location of the at least one pre-marked welding site relative to the location of the carriage and relative to the location of the at least one welding assembly.

3. The apparatus of claim 1, further comprising at least one grinding assembly connected to the carriage and being in data communication with the at least one computer, the at least one grinding assembly being operably configured to grind at least one welding site on the surface of the beam at a desired weld location that has been communicated to the at least one grinding assembly by the at least one computer.

4. The apparatus of claim 1, further comprising at least one ferrule placement assembly connected to the carriage and being in data communication with the at least one computer, the at least one ferrule placement assembly being operably configured to automatically place a ferrule on the surface of the beam at a desired weld location that has been communicated to the at least one ferrule placement assembly by the at least one computer.

5. The apparatus of claim 1, wherein the at least one data input source is an antenna that is operably configured to receive wireless signals.

6. A stud placement and welding system that is operably configured to automatically weld a stud to a surface of a beam at each of at least one desired welding sites located on the surface of the beam, the system having a computer, the system being operably configured to perform the following steps in response to the receipt of a respective electronic command signal by the computer:
move along at least a portion of a longitudinal axis of the beam; and
place and weld a stud to the surface of the beam at each of the at least one desired welding sites.

7. The system of claim 6, the system further comprising a grinding assembly, wherein the system is operably configured to automatically perform the following additional step in response to the receipt of a respective electronic command signal by the computer:
grind at least one grinding location on the surface of the beam using the grinding assembly, each of the at least one grinding locations corresponding with a respective one of the at least one desired welding sites.

8. The system of claim 6, the system further comprising a ferrule placement assembly, wherein the system is operably configured to automatically perform the following additional step in response to the receipt of a respective electronic command signal by the computer:
place at least one ferrule on the surface of the beam at a respective one of the at least one desired welding sites.

9. The system of claim 7, the system further comprising a ferrule placement assembly, wherein the system is operably configured to automatically perform the following additional step in response to the receipt of a respective electronic command signal by the computer:
place at least one ferrule on the surface of the beam at a respective one of the at least one desired welding sites.

10. The system of claim 8, the system further comprising a ferrule fracturing assembly, wherein the system is operably configured to automatically fracture the at least one ferrule in response to the receipt of a respective electronic command signal by the computer.

11. The system of claim 9, the system further comprising a ferrule fracturing assembly, wherein the system is operably configured to automatically fracture the at least one ferrule in response to the receipt of a respective electronic command signal by the computer.

12. The system of claim 6, the system further comprising at least one lens and at least one imager in data communication with the computer, the computer further comprising image acquisition software, wherein the system is operably configured to automatically perform the following additional steps in response to the receipt of a respective electronic command signal by the computer:
use the at least one lens and the at least one imager to capture at least one image of at least a portion of the surface of the beam;
transmit the at least one image to the computer; and
use the image acquisition software to determine the location of each of at least one desired welding sites located within the at least a portion of the surface of the beam based on contents of the at least one image.

13. The system of claim 6, the system further comprising at least one data input source in data communication with the computer, wherein the computer is operably configured to receive location data from the at least one data input source regarding a respective geolocation of each of the at least one desired welding sites, wherein the at least one data input source is an antenna that is operably configured to receive wireless signals.

14. A method of operating a stud placement and welding system that is operably configured to automatically weld a stud to a surface of a beam at each of at least one desired welding sites located on the surface of the beam, the system having a computer, the method comprising:
sending an electronic command signal to the computer so that the system moves along at least a portion of a longitudinal axis of the beam; and
sending an electronic command signal to the computer so that the system places and welds a stud to the surface of the beam at each of the at least one desired welding sites.

15. The method of claim 14, further comprising the step of sending an electronic command signal to the computer so that a grinding assembly of the system grinds at least one grinding location on the surface of the beam, each of the at least one grinding locations corresponding with a respective one of the at least one desired welding sites.

16. The method of claim 14, further comprising the step of sending an electronic command signal to the computer so that a ferrule placement assembly of the system places at least one ferrule on the surface of the beam at a respective one of the at least one desired welding sites.

17. The method of claim 15, further comprising the step of sending an electronic command signal to the computer so that a ferrule placement assembly of the system places at least one ferrule on the surface of the beam at a respective one of the at least one desired welding sites.

18. The method of claim 16, further comprising the step of sending an electronic command signal to the computer so that a ferrule fracturing assembly of the system automatically fractures the at least one ferrule.

19. The method of claim 17, further comprising the step of sending an electronic command signal to the computer so that a ferrule fracturing assembly of the system automatically fractures the at least one ferrule.

20. The method of claim 14, the system further comprising at least one lens and at least one imager in electrical communication with the computer, the computer further comprising image acquisition software, the method further comprising the steps of:
sending an electronic command signal from the computer to the at least one imager to use the at least one lens and the at least one imager to capture at least one image of at least a portion of the surface of the beam;
transmitting the at least one image to the computer; and
using the image acquisition software to determine the location of each of at least one desired welding sites located within the at least a portion of the surface of the beam based on contents of the at least one image.
